(19) United States
(12) Patent Application Publication
(10) Pub. No.: US 2015/0100759 A1
(43) Pub. Date: Apr. 9, 2015

(54) PIPELINED FINITE STATE MACHINE

(71) Applicant: TEXAS INSTRUMENTS DEUTSCHLAND GMBH, Freising (DE)

(72) Inventors: Christian Wiencke, Garching (DE); Marko Krüger, Freising (DE); Markus Kösler, Landshut (DE)

(73) Assignee: TEXAS INSTRUMENTS DEUTSCHLAND GMBH, Freising (DE)

(21) Appl. No.: 14/047,402

(22) Filed: Oct. 7, 2013

(51) Int. Cl. G06F 9/38

(52) U.S. Cl. CPC G06F 9/3836
USPC 712/23

(57) ABSTRACT

A system and method for controlling operation of a pipeline. In one embodiment, a pipelined datapath includes a plurality of processing stages and a pipeline controller. Each of the processing stages is configured to further processing provided by a previous one of the processing stages. The pipeline controller is configured to control operation of the processing stages. The pipeline controller includes a pipelined finite state machine. The pipelined finite state machine includes a plurality of control stages. Each of the control stages is configured to control operation of a single one of the processing stages, and to receive a state value that defines a state of the control stage for controlling the single one of the processing stages from a previous control stage.

### BACKGROUND

Pipelining is one technique employed to increase the performance of processing systems such as microprocessors. Pipelining divides the execution of an instruction (or operation) into a number of stages where each stage corresponds to one step in the execution of the instruction. As each stage completes processing of a given instruction, and processing of the given instruction passes to a subsequent stage, the stage becomes available to commence processing of the next instruction. Thus, pipelining increases the overall rate at which instructions can be executed by partitioning execution into a plurality steps that allow a new instruction to begin execution before execution of a previous instruction is complete.

The operations performed in a pipelined datapath can vary at both the pipeline level and the stage level. Accordingly, the logic that controls the operations performed by the pipeline and by the individual stages of the pipeline can be complex.

### SUMMARY

A system and method for controlling operation of a pipeline are disclosed herein. In one embodiment, a processor includes an execution pipeline and pipeline control logic. The execution pipeline is configured to execute instructions. The execution pipeline includes a plurality of sequentially arranged execution stages. The pipeline control logic is configured to control operation of the execution pipeline. The pipeline control logic includes a pipelined state machine. The pipelined state machine includes a plurality of sequentially arranged control stages. Each of the control stages is configured to control operation of a given stage of the execution pipeline, and generate a state value that defines a state for a subsequent control stage.

In another embodiment, a pipelined datapath includes a plurality of processing stages and a pipeline controller. Each of the processing stages is configured to further processing provided by a previous one of the processing stages. The pipeline controller is configured to control operation of the processing stages. The pipeline controller includes a pipelined finite state machine. The pipelined finite state machine includes a plurality of control stages. Each of the control stages is configured to control operation of a single one of the processing stages, and to receive a state value that defines a state of the control stage for controlling the single one of the processing stages from a previous control stage.

In a further embodiment, a method includes processing data in a pipelined datapath that includes a plurality of sequential processing stages. The processing provided by the processing stages includes processing a result of a first of the processing stages in a subsequent processing stage. The method further includes controlling operation of the processing stages by a pipelined state machine. The pipelined state machine includes a plurality of sequential control stages. Each of the control stages controls only one of the processing stages, and provides a control stage state value to a single subsequent control stage.

### BRIEF DESCRIPTION OF THE DRAWINGS

For a detailed description of exemplary embodiments of the invention, reference will now be made to the accompanying drawings in which:

FIG. 1 shows a block diagram of a system that employs pipelining in accordance with various embodiments;

FIG. 2 shows a block diagram of a pipelined finite state machine in accordance with various embodiments;

FIG. 3 shows a block diagram of resource arbitration logic used with a pipelined finite state machine in accordance with various embodiments;

FIG. 4 shows a flow diagram for a method for pipelined processing in accordance with various embodiments; and

FIG. 5 shows flow diagram for a method for operating a pipelined state machine in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The recitation “based on” is intended to mean “based at least in part on.” Therefore, if X is based on Y, X may be based on Y and any number of additional factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The control logic that manages the operation of a pipelined datapath, such as a microprocessor's execution pipeline, can be complex. Complex logic is often implemented as a finite state machine, and in conventional systems, the complex logic that controls a pipelined datapath is typically implemented by a very complex finite state machine. Alternatively, in a conventional implementation, multiple inter-dependent state machines may be applied to control a processing pipeline. While both of these approaches provide effective pipeline control, the complexity of the state machines necessitates a relatively large circuit area, and an oftentimes lengthy design cycle. The complexity also makes modification and verification of the state machine(s) difficult.

Embodiments of the present disclosure include a pipelined datapath controlled by a pipelined finite state machine. The pipelined finite state machine disclosed herein provides control for the stages of an execution pipeline via a single state machine that includes multiple pipelined control stages. Each of the control stages provides control to a corresponding execution stage of the execution pipeline. The pipelined finite state machine is highly structured and consequently easier to design and maintain than conventional state machines implemented to control a pipelined datapath. The pipelined finite state machine may also require less circuit area than conventional state machines that provide equivalent functionality.

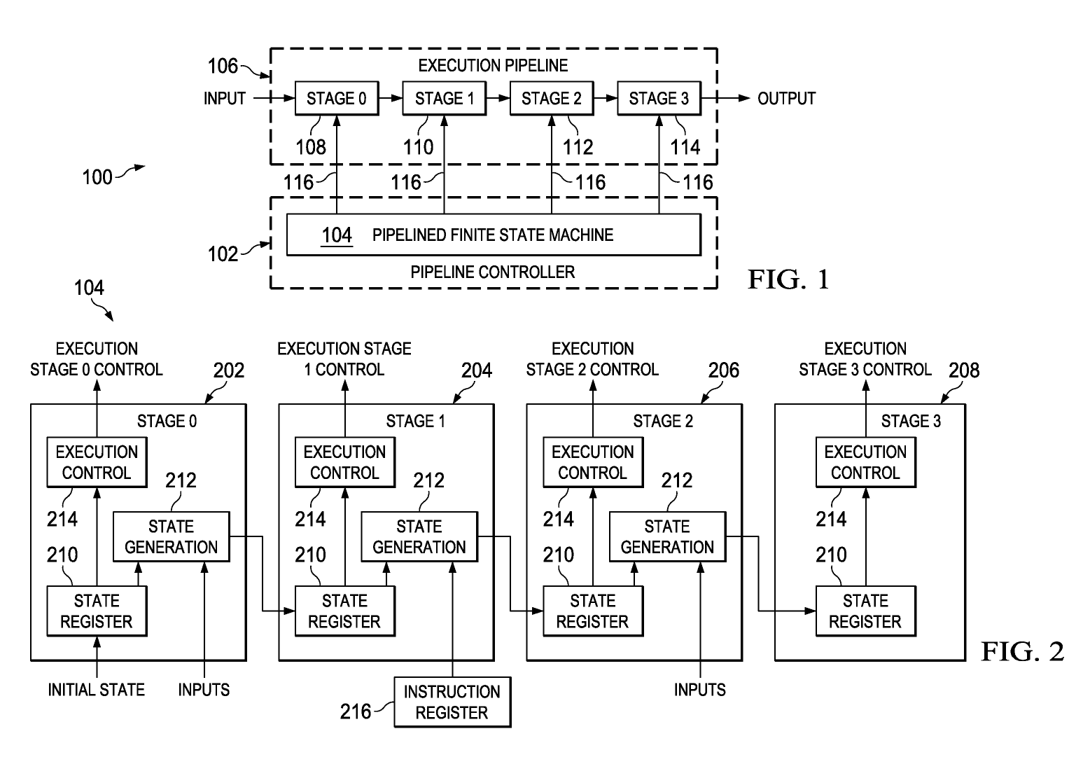

FIG. 1 shows a block diagram of a processing system 100 that employs pipelining in accordance with various embodiments. The processing system 100 may be a processor, such as a general purpose microprocessor, a microcontroller, a digital signal processor, or other system that includes a pipelined datapath. The system 100 includes an execution pipeline 106 and a pipeline controller 102. The execution pipeline 106 includes a plurality of successively coupled processing stages 108-114. Various embodiments of the execution pipeline 106 may include more or fewer stages than are illustrated in FIG. 1.

Each execution stage 108-114 provides processing functionality and each execution stage 110-114 provides processing functionality that furthers the processing provided by the previous stage. For example, in the execution pipeline 106, execution stage 0 108 perform a first operation on an input operand, execution stage 1 110 may further process the result of processing by execution stage 0 108, and so on. The operations performed by one or more of the execution stages 108-114 are controlled by and vary based on control signals 116 provided by the pipeline controller 102.

The pipeline controller 102 includes a pipelined finite state machine 104 that manages the operation of each of the execution stages 108-114 of the execution pipeline 106. The pipelined finite state machine 104 is a novel state machine structure that reduces circuit area and state machine complexity without reducing functionality.

FIG. 2 shows a block diagram of the pipelined finite state machine 104 in accordance with various embodiments. The pipelined state machine 104 includes a plurality of sequentially coupled control stages 202-208. Each of the control stages 202-208 controls the operation of one stage of a pipelined datapath. For example, control stage 0 202 controls the operation of processing stage 0 108, control stage 1 204 controls the operation of processing stage 1 110, control stage 2 206 controls the operation of processing stage 2 112, and so on. The number of control stages included in an embodiment of the pipelined finite state machine 104 may vary. For example, the number of control stages of the pipelined finite state machine 104 may vary in accordance with the number of processing stages of a pipelined datapath controlled by the pipelined finite state machine 104.

Each of the control stages 202-208 includes a state register 210 and execution control logic 214. Each of control stages 202-206 further includes state generation logic 212. In a conventional state machine, a state register holds a current state value defining a current state of the state machine. The current state value is fed back into next state generation logic that determines a next state value that defines a next state of the state machine (based on the current state value) and loads the next state value into the state register. Thus, in a conventional state machine, the current value of the state register determines, at least in part, the next value of the state register.

In contrast to the conventional state machine, the pipelined finite state machine 104 includes a plurality of state registers 210, one state register 210 per control stage. The state register 210 of each of the control stages 204-208 is coupled to the immediately preceding control stage 202-206. For each of control stages 204-208, the value stored in the state register 210 is determined in and by the immediately preceding control stage 202-206. Thus, the next state value for storage in each state register 210 is not based on the state value currently stored in the state register 210, but is determined by the previous control stage without reference to the current state value.

The state generation logic 212 of each control stage 202-206 determines a next state value for the successive control stage 204-208. That is, the state generation logic 212 of control stage 202 determines a next state value for control stage 204, the state generation logic 212 of control stage 204 determines a next state value for control stage 206, and the state generation logic 212 of control stage 206 determines a next state value for control stage 208. The state generation logic 212 of a control stage is coupled to the state register 210 for the control stage, and determines, based on the state value of the state register 210 of the control stage, the next state value for the successive control stage. The state value generated by the state generation logic 212 of a control stage may be transferred to the state register 210 of the successive control stage on a next clock cycle, a next pipeline cycle, etc. The state generation logic 212 may also receive input signals provided to the control stage, and determine the next state value for the successive stage based on the received input signals. For example, in an embodiment where the execution pipeline 106 is a microprocessor pipeline, the input signals may be provided from an instruction register 216. Accordingly, the input signals may specify what instruction is being processed in the execution stage controlled by the control stage, and corresponding, specify what instruction will be processed in the successive stage during the next pipeline cycle. Input signals to the state generation logic 212 may also include signals provided by various datapath resources or resources external to the pipelined datapath. For example, a data bus ready signal or other signal generated by a resource may be received as an input signal by the state generation logic 212 and affect instruction execution in the pipelined datapath.

The execution control logic 214 of each control stage 202-208 is also coupled to the state register 210 of the control stage. The execution control logic 214 generates control signals 116 that control the operations performed by the processing stage coupled to the control stage. The execution control logic 214 determines what operations are to be performed by the processing stage based on the state value stored in the state register 210.

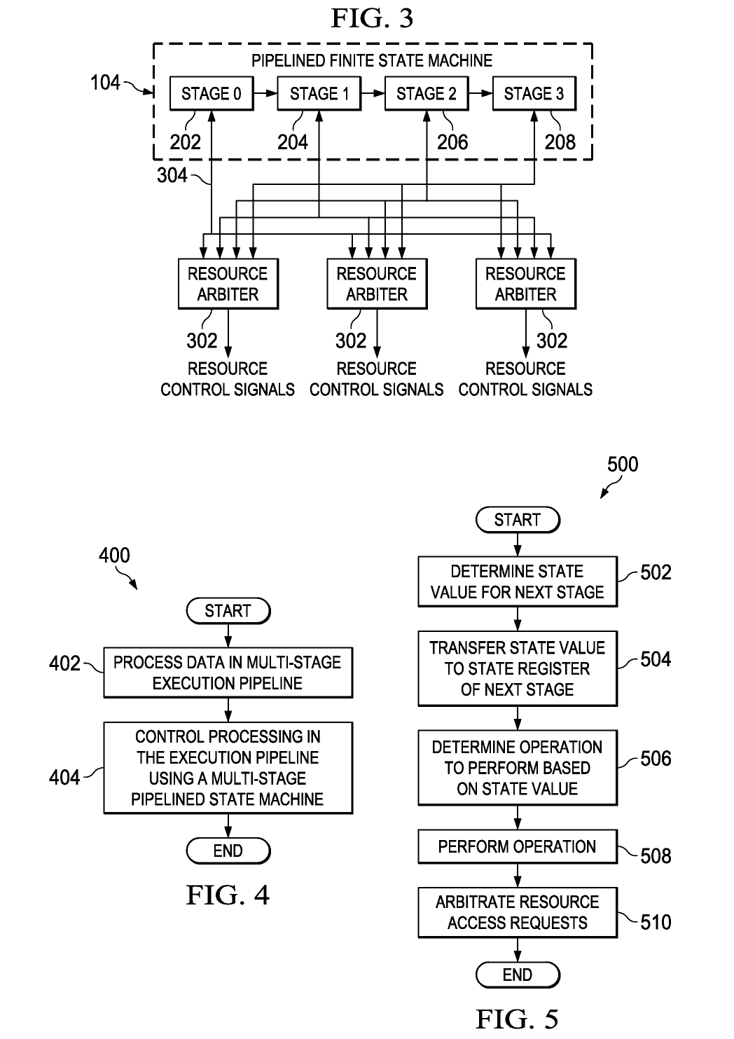

In a pipelined system, conflicts or hazards can arise when different stages of the pipeline attempt to simultaneously access the same resource. Embodiments of the processing system disclosed herein may include arbitration logic that operates in conjunction with the pipelined state machine 104 to resolve resource conflicts. FIG. 3 shows a block diagram of resource arbitration logic used with the pipelined finite state machine 104 in accordance with various embodiments. In FIG. 3, a plurality of resource arbiters 302 are coupled to each control stage 202-208 of the pipelined finite state machine 104. Each of the resource arbiters 302 may manage access to a resource, or to multiple resources. A resource for which a resource arbiter 302 manages access may be, for example, a register, a calculation unit (e.g. an ALU), a datapath multiplexer, a memory, a peripheral device, etc.

Each of the control stages 202-208 asserts a request signal 304 to request access to resource. The request signal 304 is received by a resource arbiter 302 that manages access to the resource. The resource arbiter 302 determines whether a requesting control stage can be granted access to the resource, and if access can be granted to the requesting control stage, then the resource arbiter 302 asserts a grant signal that notifies the requesting control stage of the granted access request. In the event that the access request is not granted, the pipelined finite state machine 104 may stall operation of one or more stages of the pipelined datapath until access to the resource is granted.

The resource arbiters 302 may prioritize conflicting requests for resource access based on various factors. For example, priorities may be set based on the sequence of input connections of resource request lines connecting the control stages 202-208 to each resource arbiter 302. Alternatively, a priority value for each control stage 202, and/or each resource request may be permanently or programmably recorded in the resource arbiter 302, or provided by the requesting control stage in conjunction with a resource request. The resource arbiter 302 may grant access to a resource to a highest priority requesting control stage 202-208.

FIG. 4 shows a flow diagram for a method 400 for pipelined processing in accordance with various embodiments. Though depicted sequentially as a matter of convenience, at least some of the actions shown can be performed in a different order and/or performed in parallel. Additionally, some embodiments may perform only some of the actions shown.

In block 402, the execution pipeline 106 is operating. The multiple processing stages of the execution pipeline are simultaneously processing data, and each successive processing stage is furthering towards completion the processing provided by the preceding stage.

In block 404, the execution pipeline 106, and the plurality of processing stages of the execution pipeline 106 are being controlled by a pipelined finite state machine 104. The pipelined finite state machine 104 includes a plurality of control stages. One of the control stages corresponds to and controls each processing stage of the execution pipeline 106. A state value that controls the operation of each control stage is set by state generation logic of an immediately preceding control stage.

FIG. 5 shows a flow diagram for operating a pipelined state machine 104 in accordance with various embodiments. Though depicted sequentially as a matter of convenience, at least some of the actions shown can be performed in a different order and/or performed in parallel. Additionally, some embodiments may perform only some of the actions shown. The operations of the method 500 may be performed as part of the operations of block 404 of the method 400.

In block 502, each control stage of the pipelined finite state machine 104, that is coupled to a successive control stage, determines a next state value for the successive control stage. The next state value may be generated as function of the current state value of the control stage generating the next state value. The next state value may also be based on values of input signals and/or input values (e.g., instruction identifiers) received by the control stage generating the next state value.

In block 504, each control stage of the pipelined finite state machine 104 that generated a next state value for the successive control stage, transfers the next state value to the successive control. The transferred next state value is stored in a state register 210 of the receiving control stage and serves as the state value that directs operation of the receiving control stage.

In block 506, each control stage of the pipelined finite state machine 104 determines, based on the state value stored in the state register 210 of the control stage, what operation(s) is to be performed in the processing stage managed by the control stage. The operation determination may also be based on input signals received by the control stage.

In block 508, responsive to determination of the operation(s) to be performed, in block 506, each control stage drives control signals to the corresponding processing stage, and the processing stage performs the operation(s) determined in block 506 as indicated by the control signals.

In block 510, each control stage determines whether a resource outside the execution pipeline is to be accessed as part of the operation(s) performed by the corresponding pipeline stage. A resource may be a shared register, a shared calculation unit (e.g. an ALU), a shared datapath multiplexer, a shared memory, a shared peripheral, etc. If a resource is to be accessed, then the control stage issues a resource request to a resource arbiter 302 that controls access to the resource. The resource arbiter 302 determines whether access to the resource is to be granted to the requesting control stage, and if access is to be granted, the resource arbiter asserts a resource grant signal to the requesting control stage. Failure to receive a resource acknowledgement signal in response to a resource request may be a factor in next state determination.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A processor, comprising:
an execution pipeline configured to execute instructions, the execution pipeline comprising a plurality of sequentially arranged execution stages; and
pipeline control logic configured to control operation of the execution pipeline, the pipeline control logic comprising:
a pipelined state machine comprising a plurality of sequentially arranged control stages, each of the control stages configured to:
control operation of a given stage of the execution pipeline; and
generate a state value that defines a state for a subsequent control stage.

2. The processor of claim 1, further comprising resource arbitration logic coupled to the control stages, the resource arbitration logic configured to determine which of the control stages is granted access to a resource by resolving conflicting resource access requests issued by the control stages of the pipeline control logic.

3. The processor of claim 1, wherein each of the control stages comprises:
a state register; and
stage control logic configured to generate, based on a state value provided by the state register, the state value for the subsequent control stage.

4. The processor of claim 3, wherein the stage control logic is configured to, based on the state value provided by the state register:
determine an operation to be performed by the given stage of the execution pipeline; and
generate signals that cause the given stage of the execution pipeline to perform the operation.

5. The processor of claim 3, further comprising resource arbitration logic coupled to the control stages, the resource arbitration logic configured to resolve conflicting resource allocation requests issued by different stages of the execution pipeline; wherein the stage control logic of each of the control stages is coupled to the arbitration logic; wherein the stage control logic is configured to provide a resource request signal to the resource arbitration logic, and wherein the resource arbitration logic is configured to provide a resource access grant signal to the stage control logic.

6. The processor of claim 3, wherein for each of the control stages, a next state value provided to the state register is invariably independent of a current state value provided by the state register.

7. The processor of claim 3, wherein the stage control logic of a given control stage is configured to generate the state value for the subsequent control stage based on a value of an input signal received by the given control stage in addition to the state value provided by the state register of the given control stage.

8. The processor of claim 7, wherein the input signal is an instruction provided by an instruction register coupled to the given control stage.

9. A pipelined datapath, comprising:
a plurality of processing stages, each of the processing stages configured to further processing provided by a previous one of the processing stages; and
a pipeline controller configured to control operation of the processing stages, the pipeline controller comprising:
a pipelined finite state machine comprising a plurality of control stages, wherein each of the control stages is configured to:
control operation of a single one of the processing stages; and
receive a state value that defines a state of the control stage for controlling the single one of the processing stages from a previous control stage.

10. The pipelined datapath of claim 9, wherein each of the control stages comprises:
a state register; and
stage control logic;
wherein the state register is coupled to the stage control logic of the previous control stage, and the stage control logic of the previous control stage is configured to generate a state value for storage in the state register.

11. The pipelined datapath of claim 10, wherein the stage control logic of the previous control stage is configured to generate the state value based on a state value output of the state register of the previous control stage.

12. The pipelined datapath of claim 11, wherein the stage control logic of the previous control stage is further configured to generate the state value based on a value of an input signal received by the previous control stage.

13. The pipelined datapath of claim 9, further comprising resource arbitration logic coupled to the control stages, the resource arbitration logic configured to resolve conflicting resource allocation requests issued by different control stages of the pipeline controller.

14. The pipelined datapath of claim 13, wherein each of the control stages is configured to request access to a resource by asserting a resource request signal to the resource arbitration logic, and wherein the resource arbitration logic is configured to prioritize resource request signals, and, based on the prioritization, grant access to the resource to a selected control stage by asserting a resource allocation acknowledgement signal to the selected control stage.

15. The pipelined datapath of claim 9, wherein no next state value of a given control stage is determined based on a current state value stored in the given control stage.

16. A method, comprising:
processing data in a pipelined datapath comprising a plurality of sequential processing stages, wherein the processing provided by the processing stages comprises processing a result of a first of the processing stages in a subsequent processing stage; and
controlling operation of the processing stages by a pipelined state machine, wherein the pipelined state machine comprises a plurality of sequential control stages, each of the control stages controlling only one of the processing stages, and providing a state value to a single subsequent control stage.

17. The method of claim 16, further comprising
determining, by each of the control stages, a state value for a next sequential stage of the pipelined state machine;
transferring the state value to a state register that controls only the next sequential stage of the pipelined state machine;
determining, by the next sequential stage of the pipelined state machine, based on the state value transferred to the state register, an operation to be performed by a processing stage controlled by the next sequential stage;
performing, by the processing stage, the determined operation.

18. The method of claim 17, wherein determining the state value for the next sequential stage comprises generating the state value based on a current state value stored in a state register of the control stage generating the state value.

19. The method of claim 17, wherein determining the state value for the next sequential stage comprises generating the state value based on an input signal received by the control stage generating the state value.

20. The method of claim 16, further comprising:
determining which of the control stages of the pipelined datapath is granted access to a resource based on more than of the control stages requesting access to the resource;
granting access to the resource to one of the control stages based on the determining.
